(19) United States
(12) Patent Application Publication
(10) Pub. No.: US 2008/0291363 A1
(43) Pub. Date: Nov. 27, 2008

(54) ELECTRO-OPTIC DEVICE, ELECTRONIC APPARATUS AND ILLUMINATION DEVICE

(75) Inventor: Yasunori ONISHI, Azumino-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: EPSON IMAGING DEVICES CORPORATION, Azumino-shi (JP)

(21) Appl. No.: 11/738,117

(22) Filed: Apr. 20, 2007

(30) Foreign Application Priority Data
Jul. 31, 2006 (JP) 2006-207520
Feb. 2, 2007 (JP) 2007-023806

(51) Int. Cl. G02F 1/1335; F21V 8/00

(52) U.S. Cl. 349/64; 362/615

(57) ABSTRACT

An electro-optic device includes a light source, a light guide panel configured to output light beams emitted from the light source through a light exit plane; a display panel illuminated by the light beams outputted from the light exit plane of the light guide panel passing therethrough; a prism sheet provided between the light guide panel and the display panel and formed with prisms having a triangular cross-section on a surface on the side of the display panel; and a light diffusing member provided between the light guide panel and the prism sheet. The prisms each having a ridge line extending substantially vertically to the direction of emission of the light beam emitted from the light source, and an apex angle is set to a range from 60° to 70°.

The entire disclosure of Japanese Patent Application Nos. 2006-207520, filed Jul. 31, 2006 and 2007-023806, filed Feb. 2, 2007 are expressly incorporated by reference herein.

### BACKGROUND

1. Technical Field

The present invention relates to an electro-optic device suitable to be used for displaying various information.

2. Related Art

In a liquid crystal device, an illumination device is provided on the back side of a liquid crystal display panel for achieving transmissive display. In general, the illumination device includes a light source, a light guide panel that converts light from the light source into a planar light and guides the same onto the back side of the liquid crystal display panel, a sheet that diffuses light outgoing from the light guide panel, and a prism sheet that converges light.

The light incoming from the light source to the light guide panel repeats reflection between an light exit plane and a reflecting plane of the light guide panel, and goes out through the light exit plane. The light outputted from the light guide panel enters the prism sheet. The prism sheet has prisms each having a triangular cross-section, and refracts incoming light by the prism to change the direction of the light. Accordingly, the prism sheet causes the light to go out toward the liquid crystal panel.

However, two prism sheets are used in the general illumination device and the two prism sheets are arranged so that respective ridge lines of the prisms extend orthogonally to each other. Therefore, a range that outgoing light from the illumination device concentrates is only about 25° at half angle at half maximum.

JP-A-2003-35825 proposes a technology to reduce uneven luminance occurring in an illumination device by forming prisms on a light exit plane of a light guide panel having a single point light source at an end surface thereof concentrically about the point light source.

### SUMMARY

An advantage of some aspects of the invention is to provide an electro-optic device which achieves a wide visual angle.

According to an aspect of the invention, an electro-optic device includes a light source, a light guide panel configured to output light beams emitted from the light source through a light exit plane; a display panel illuminated by the light beams outputted from the light exit plane of the light guide panel passing therethrough; a prism sheet provided between the light guide panel and the display panel and formed with prisms having a triangular cross-section on a surface on the side of the display panel; and a light diffusing member provided between the light guide panel and the prism sheet, wherein the prisms are formed in such a manner that the ridge lines thereof extend substantially vertically to the direction of light beams emitted from the light source, and the apex angle is set to the range from 60° to 70°.

The electro-optic device is, for example, a liquid crystal device, and includes the light source, the light guide panel, the display panel, the prism sheet and the light diffusing member. The light guide panel outputs the light beams emitted from the light source through the light exit plane. The display panel is, for example, a liquid crystal display panel, and is illuminated by the light beams outputted through the light exit plane of the light guide panel passing therethrough. The prism sheet is installed between the light guide panel and the display panel, and is formed with the prisms having a triangular cross-section on the surface on the side of the display panel. The prisms are formed in such a manner that the ridge lines thereof extend substantially vertically to the direction of light beams emitted from the light source, and the apex angle is set to the range from 60° to 70°. The light diffusing member is, for example, a diffusing sheet, and is installed between the light guide panel and the prism sheet. Accordingly, in the electro-optic device according to the embodiment of the invention, a range in which the desirable luminance is achieved is widened in comparison with a general electro-optic device in which two prism sheets having prisms whose apex angle is 90° are laid on one top of another.

It is preferable that the light guide panel is formed with grooves having a triangular cross-section on a reflecting plane, and the angle of inclination of the each triangular groove on the side of the light source is set to a range from 0.10° to 5°. Accordingly, in the electro-optic device according to the embodiment of the invention, peaks of the luminance are concentrated to an area near the center of a screen.

It is preferable that the light diffusing member is a diffusing sheet, and the diffusing sheet is further provided between the light guide panel and the prism sheet, and the diffusing sheet is applied with a plurality of beads on a surface thereof. Accordingly, the diffusing sheet is provided with a light converging function. Therefore, according to the electro-optic device in the embodiment of the invention, the luminance is improved.

It is preferable that the prism sheet is applied with beads on a surface on the side of the light guide panel as the light diffusing member. Accordingly, the prism sheet is provided with a light converging function. Therefore, according to the electro-optic device in the embodiment of the invention, the luminance is improved, and since the diffusing sheet is not provided, the thin profile is achieved correspondingly.

It is preferable that the display panel is a liquid crystal display panel, wherein when the vertical direction of the liquid crystal display panel is assumed to be 0°, a range in which the contrast ratio is at least 10:1 is at least ±60° in the lateral direction of the display panel. In the liquid crystal device, a characteristic that a contrast characteristic depends on the visual angle caused by birefringence of the liquid crystal is generally known in addition to the above-described lowering of the luminance. That is, when the liquid crystal device is viewed from the oblique direction, the contrast characteristic is deteriorated and hence the liquid crystal device is no longer suitable for being viewed. That is, the liquid crystal device will be further suitable for being viewed by achieving desirable luminance characteristics in a wider angular range and, in addition, by setting the contrast characteristic adequately in this angular range. More specifically, it is achieved by setting the visual angle characteristic to obtain the lateral contrast characteristic of 10:1 in a range wider than the range of the visual angle from 0° to ±60°, in which an attempt is made to improve the luminance characteristics by the invention. In contrast, in the visual angle out of the range of the visual angle from 0° to ±60°, a sufficient luminance characteristic cannot be obtained even though the contrast characteristics are desirably set. Therefore, necessity to maintain the desirable contrast characteristic is relatively low. The object of the invention is almost achieved as long as the contrast characteristic is at least 10:1 at a visual angle from 0° to ±80°. In order to achieve the object, for example, a visual angle compensating layer may be provided at least on one side of the display panel. The visual angle compensating layer such as a visual angle compensating layer in which an expression nx=ny>nz (nx and ny represent refractive indexes in the x and y directions in the film surface, and nz represents an refractive index in the thickness direction) is satisfied, a visual angle compensating panel having a relation nx>ny=nz, a liquid crystal film in which nematic hybrid alignment is fixed so that the liquid crystal is aligned obliquely in the thickness direction, or a liquid crystal film in which discotic hybrid alignment is fixed is arranged independently or in combination on the front or back or the both sides of the display panel according to the type of the display panel. According to another aspect of the invention, an electronic apparatus having the electro-optic device described above as a display unit is provided.

According to still another aspect of the invention, an illumination device includes a light source, a light guide panel configured to output light beams emitted from the light source through a light exit plane, and a prism sheet installed on the side of the light exit plane of the light guide panel and being formed with prisms having a triangular-cross section on a surface opposite from the side of the light guide panel, and the prisms each have a ridge line extending substantially vertically to the direction of emission of the light beam emitted from the light source, and an apex angle is set to a range from 60 to 70°. With this illumination device as well, a range in which the desirable luminance is achieved is widened.

### BRIEF DESCRIPTION OF THE DRAWINGS

The invention will be described with reference to the accompanying drawings, wherein like numbers reference like elements.

FIG. 1 is a cross-sectional view showing a schematic configuration of a liquid crystal device according to an embodiment.

FIG. 2 is a plan view showing the positional relation between a light guide panel and a prism sheet.

FIGS. 3A and 3B are cross-sectional views showing schematic configurations of the liquid crystal device.

FIGS. 4A and 4B are cross-sectional views showing schematic configurations of the liquid crystal device.

FIGS. 5A and 5B are cross-sectional views showing schematic configurations of the liquid crystal device.

FIGS. 6A and 6B are graphs showing the relation between a visual angle and the luminance in the liquid crystal device.

FIGS. 7A and 7B are graphs showing the relation between the visual angle and the luminance in the liquid crystal device.

FIGS. 8A and 8B are graphs showing the relation between the visual angle and the luminance in the liquid crystal device.

FIG. 9A is a schematic drawing showing an electronic apparatus to which the liquid crystal device according to the embodiment of the invention is applied.

FIG. 9B is a schematic drawing showing an electronic apparatus to which the liquid crystal device according to the embodiment of the invention is applied.

### DESCRIPTION OF EXEMPLARY EMBODIMENTS

Referring now to the drawings, preferred embodiments of the invention will be described. In the following embodiments, an illumination device according to an aspect of the invention is applied to a liquid crystal device.

### Configuration of Liquid Crystal Device

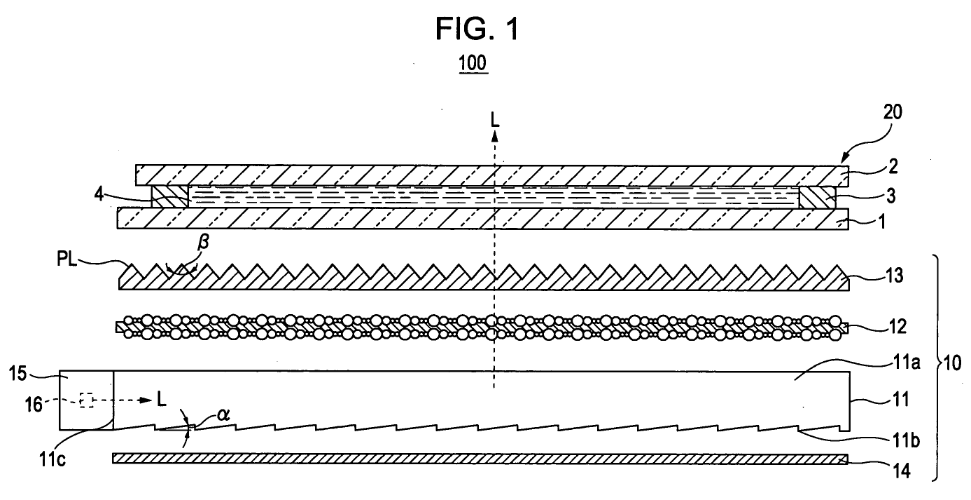

FIG. 1 is a cross-sectional view of a liquid crystal device 100 according to an embodiment. The liquid crystal device 100 mainly includes an illumination device 10 and a liquid crystal display panel 20. The liquid crystal display panel 20 is configured in such a manner that substrates 1 and 2 such as glass are bonded together via a sealing material 3 to form a cell structure, and liquid crystal 4 is encapsulated therein. Arranged on the front and back sides of the liquid crystal display panel 20 are polarizing panels, not shown, and a wave panel and a visual angle compensating panel are provided between the liquid crystal display panel 20 and the polarizing panels.

The illumination device 10 mainly includes a light guide panel 11 and a light source 15. The liquid crystal display panel 20 is arranged on the upper side of the light guide panel 11 so as to oppose thereto. The illumination device 10 is provided with a reflection sheet 14 on the lower surface side of the light guide panel 11.

The light source 15 is arranged on an end surface 11c of the light guide panel 11, and is provided with a plurality of LEDs 16 as a point light source.

Light beams L emitted from the respective LEDs 16 enter the light guide panel 11 through the end surface 11c of the light guide panel 11. An upper surface functions as a light exit plane 11a for outputting the light beams, and the lower surface functions as a reflecting plane 11b that reflects the light beams in the light guide panel 11. The light beams L change the direction by repeating reflection between the light exit plane 11a and the reflecting plane 11b of the light guide panel 11, and go out through the light exit plane 11a to the outside. The outgoing light beams L proceed toward the liquid crystal display panel 20.

The illumination device 10 further includes a diffusing sheet 12 and a prism sheet 13. The diffusing sheet 12 and the prism sheet 13 are installed between the light guide panel 11 and the liquid crystal display panel 20, and are installed from the side of the light exit plane 11a of the light guide panel 11 in sequence. The light beams L outputting from the light guide panel 11 pass through the diffusing sheet 12 and the prism sheet 13, and then pass through the liquid crystal display panel 20, so that illumination is achieved.

The diffusing sheet 12 basically has a role to diffuse the light beams L outputting from the light guide panel 11 to all directions. The diffusing sheet 12, being different from a general diffusing sheet, is applied with a plurality of beads formed of ultra-fine particles on a surface thereof, and has a high light converging function in comparison with general diffusing sheet because the beads function as, so-called, microlenses to converge incoming light beams. Through the usage of the diffusing sheet 12 according to the embodiments of the invention, the luminance of the light beams outputting from the diffusing sheet 12 is enhanced, and the luminance of a display screen of the liquid crystal device 100 is enhanced.

The prism sheet 13 has a role to converge the light beams L onto the liquid crystal display panel 20. The prism sheet 13 is formed with prisms having a triangular cross-section on the surface on the side of the liquid crystal display panel 20, that is, on the surface opposite from the light guide panel 11. The ridge lines of the prisms are indicated as “PL”.

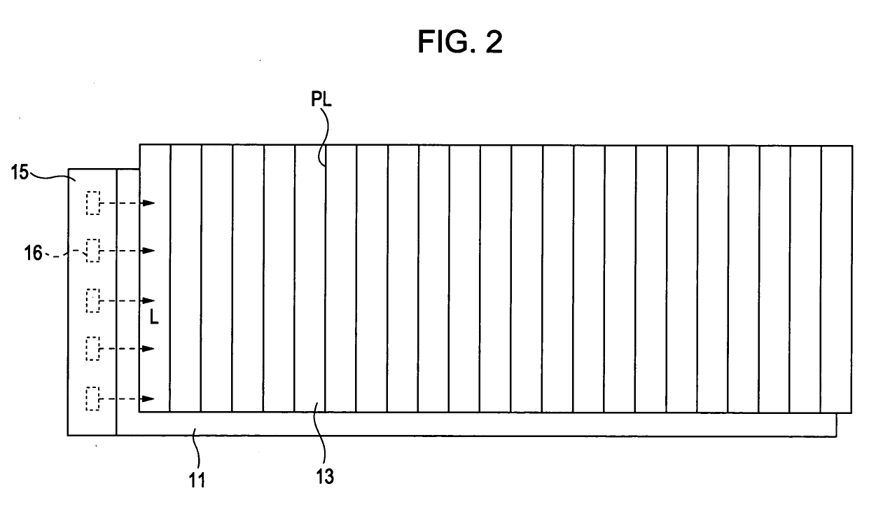

FIG. 2 is a plan view showing a positional relation between the light guide panel 11 and the prism sheet 13. As shown in FIG. 2, the ridge lines of the prisms PL are substantially vertical to the direction of emission of the light beams L emitted from the LEDs 16 of the light source 15. In other words, the prism sheet 13 has a shape having prisms whose ridge lines are extending in the direction vertical to the direction of emission of the light beams L.

In the liquid crystal device 100 according to this embodiment, as will be described in detail later, an apex angle β of the prism on the prism sheet 13 is set within a range from 60° to 70°. In this arrangement, a desirable liquid crystal device having a desired luminance in a wide angular range in comparison with the general liquid crystal device is provided.

In the liquid crystal device 100 according to the embodiment, as will be described in detail later, the light guide panel 11 is formed with grooves having triangular cross-section on the reflecting plane 11b as shown in FIG. 1, and an angle of inclination α of each triangular groove on the side of the light source 15 is set to a range from 0.1 to 5°. In this configuration, the peak of luminance may be concentrated on the area around the center of the screen.

Change of Visual Angle and Luminance according to the Configuration of the Device

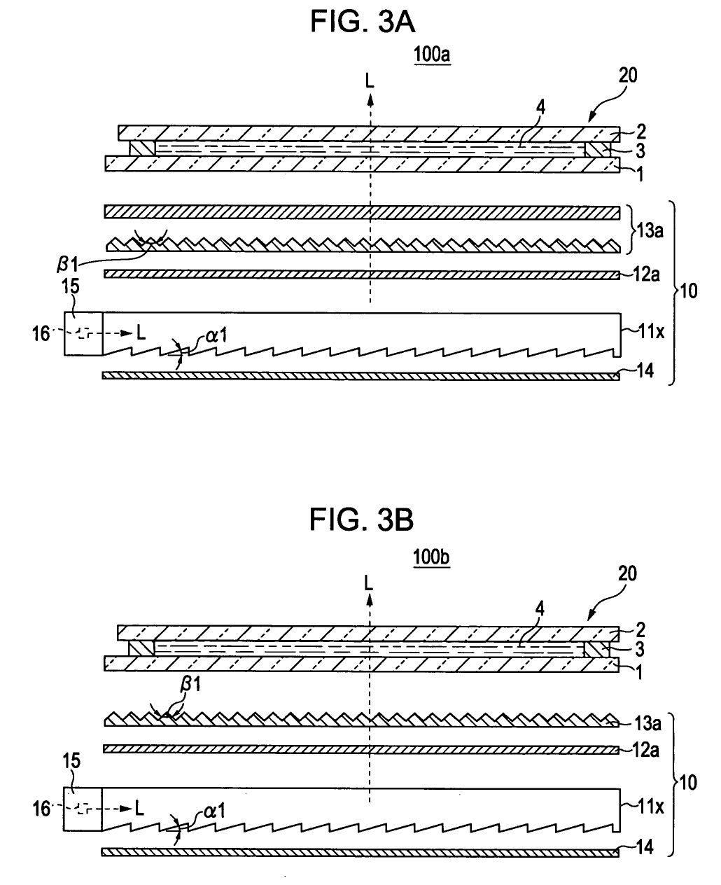

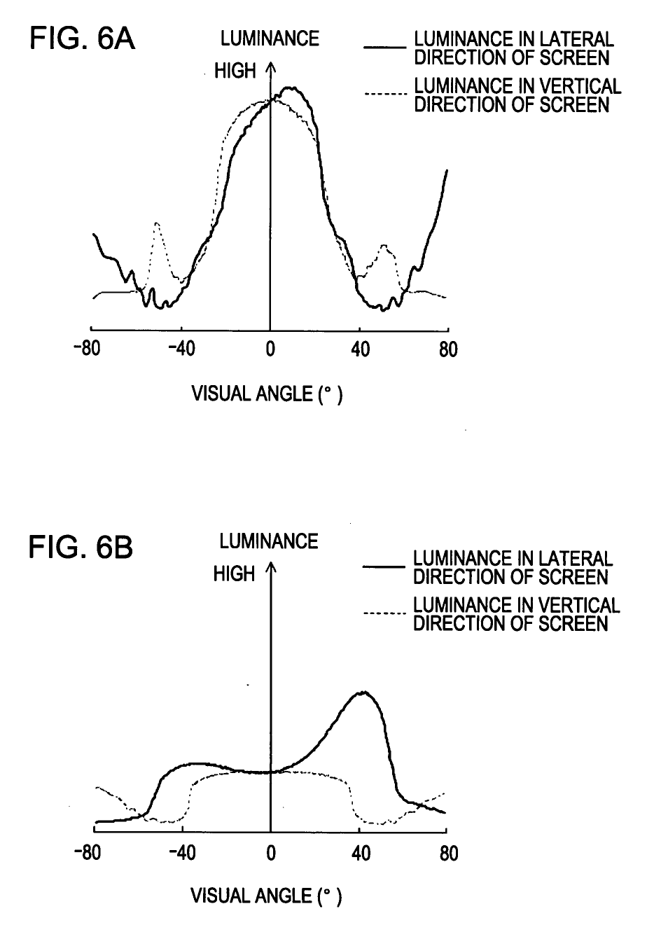

Referring now to FIG. 3A to FIG. 8B, a change of visual angle and the luminance according to the configuration of the liquid crystal device will be described. FIG. 3A to FIG. 5B show liquid crystal devices in various configurations, and FIG. 6A to FIG. 8B are graphs showing the relation between the visual angle and the luminance in the liquid crystal devices in various configurations. In the graphs from FIG. 6A to FIG. 8B, solid lines indicate the relation between the visual angle and the luminance in the lateral direction of the screen, and broken lines indicate the relation between the visual angle and the luminance in the vertical direction of the screen. Here, the lateral direction of the screen corresponds to the lateral direction of paper planes of FIG. 3A to FIG. 5B, and the vertical direction of the screen corresponds to the vertical direction of the paper planes of FIG. 3A to FIG. 5B. The term “visual angle” means an angle at which the observer can view the liquid crystal device 100 in the lateral direction of the screen, and in the liquid crystal device, it is highly necessary to widen the angular range with a high luminance in the lateral direction of the screen. Therefore, in the description given below, the relation between the visual angle and the luminance in the lateral direction of the screen will be described.

FIG. 3A shows a configuration of a general liquid crystal device 100a.

In the general liquid crystal device 100a, being different from the liquid crystal device 100 according to the embodiment described above, a general diffusing sheet 12a is arranged instead of the diffusing sheet having the converging function and two general prism sheets 13a having prisms whose apex angle β1 is 90° are arranged instead of the prism sheet 13 having prisms whose apex angle β is in the range from 60° to 70°. There, the two prism sheets 13a are laid one on top of another so that the ridge lines of the prisms extend orthogonally to each other. In FIG. 3A, the prism sheet 13a having prisms extending in the lateral direction of the paper plane and the prism sheet 13a having prisms extending in the vertical direction of the paper plane are laid one on top of another.

In the general liquid crystal device 100a, being different from the liquid crystal device 100 according to the embodiment described above, a light guide panel 11x formed with grooves on the reflecting plane, having triangular cross-section and having an angle of inclination α1 on the side of the light source 15 set to 25°, is arranged instead of the light guide panel 11 described above.

FIG. 6A shows the relation between the visual angle and the luminance in the general liquid crystal device 100a. As seen in FIG. 6A, the luminance of the general liquid crystal device 100a abruptly drops at a visual angle of ±25° in the lateral direction of the screen. That is, in the general liquid crystal device 100a, the visual angle which makes the luminance characteristics effective is only in the range of ±25°.

FIG. 3B shows a configuration of a liquid crystal device 100b which corresponds to the liquid crystal device 100a but there is only one prism sheet 13a.

More specifically, the liquid crystal device 100b corresponds to the liquid crystal device 100a but the prism sheet 13a having the prisms extending in the lateral direction of the paper plane is removed. Therefore, the liquid crystal device 100b only has the prism sheet 13a having the prisms extending in the vertical direction of the paper plane as the prism sheet.

FIG. 6B shows the relation between the visual angle and the luminance in the liquid crystal device 100b. As seen in FIG. 6B, the luminance of the liquid crystal device 100b abruptly drops at a visual angle of ±60° in the lateral direction of the screen. That is, in the liquid crystal device 100b, the effective visual angle is on the order of ±60°, and hence the range of visual angle which achieves desired luminance is increased in comparison with the liquid crystal device 100a.

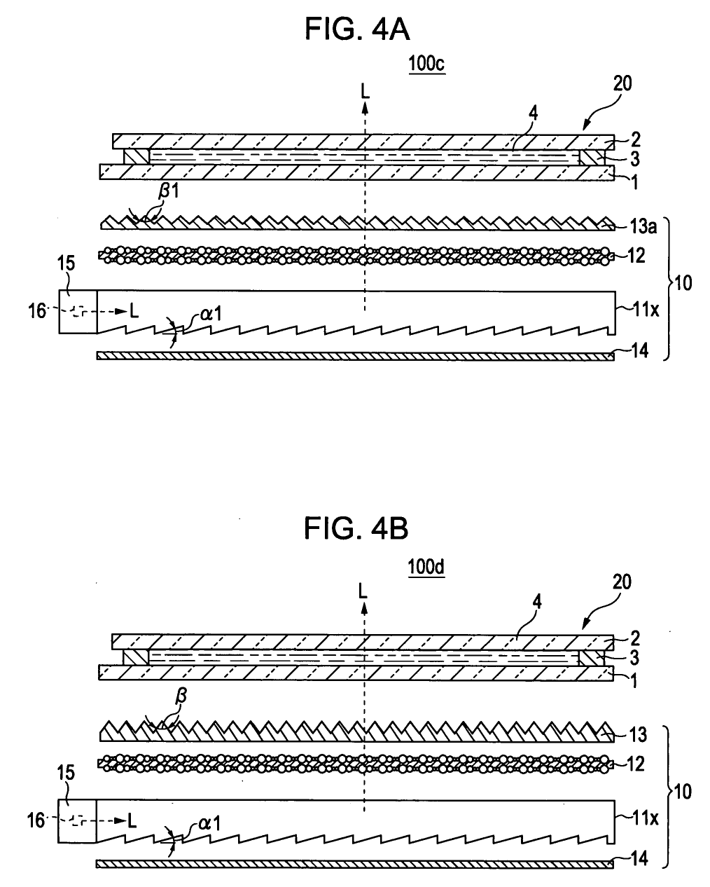

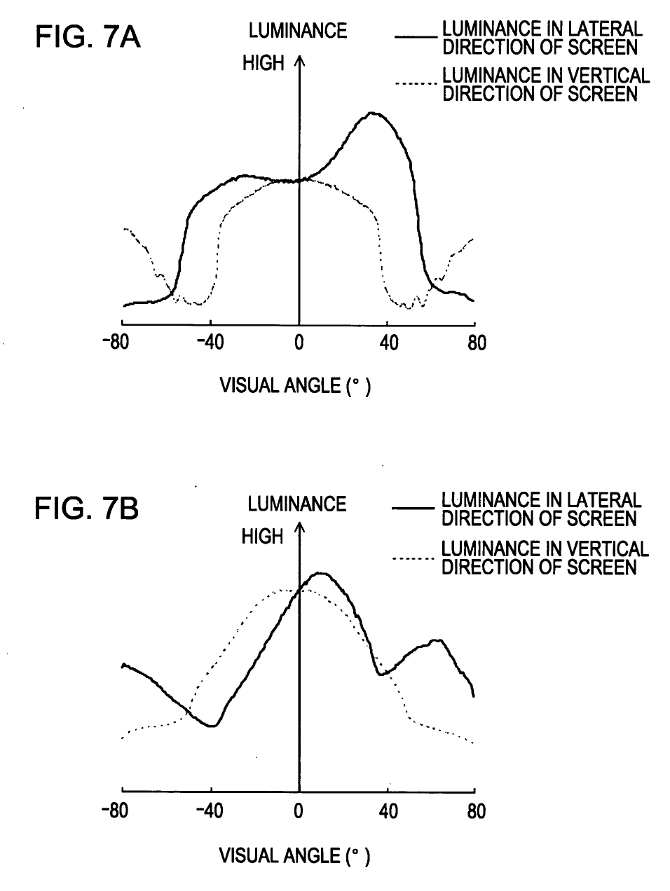

FIG. 4A shows a configuration of a liquid crystal device 100c which corresponds to the liquid crystal device 100b but the diffusing sheet 12a is replaced by the diffusing sheet 12. FIG. 7A shows the relation between the visual angle and the luminance in the liquid crystal device 100c. When FIG. 7A and FIG. 6B are compared, it is seen that the luminance in the range of the effective visual angle ±60° may be improved by arranging the diffusing sheet 12 having a high converging function.

FIG. 4B shows a configuration of a liquid crystal device 100d which corresponds to the liquid crystal device 100c but the prism sheet 13a is replaced by the prism sheet 13. FIG. 7B shows the relation between the visual angle and the luminance in the liquid crystal device 100d. In this embodiment, the apex angle β of the prism sheet 13 is set to 63°.

As seen in FIG. 7B, the luminance of the liquid crystal device 100d is different from the luminance of the liquid crystal device 100c, and does not drop even at a visual angle exceeding the range of ±60° in the lateral direction of the screen. For example, the luminance of the liquid crystal device 100d does not drop at a visual angle near ±80° in the lateral direction of the screen. As will be seen from the description above, by changing the apex angle of the prism on the prism sheet from 90° to 63°, the range of the visual angle which can provide a desired luminance in the lateral direction of the screen of the liquid crystal device may be widened in comparison with the general liquid crystal device 100a. The range of the value of the apex angle β of the prism which can widen the visual angle may be a certain range including 63°, and the range of the visual angle which provides a desirable luminance as described above may be widened when the range is from 60° to 70°.

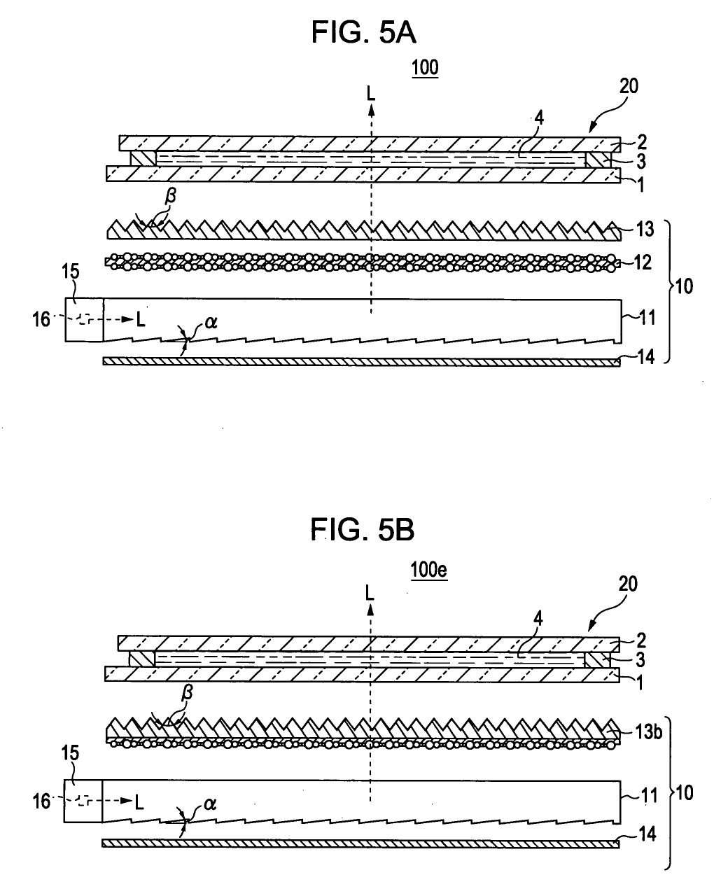

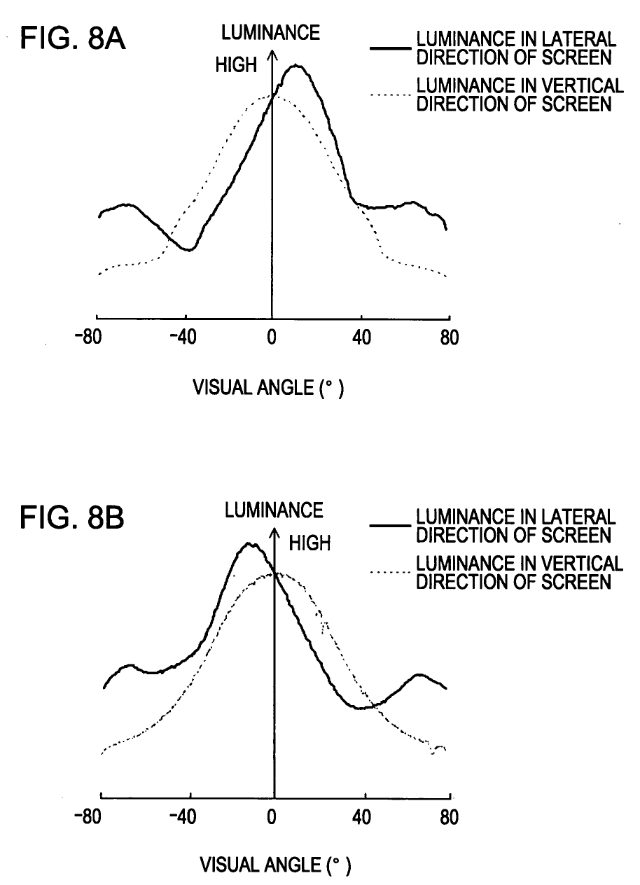

FIG. 5A shows a configuration of the liquid crystal device 100 according to the embodiment. The liquid crystal device 100 has a configuration which corresponds to the liquid crystal device 100d but the light guide panel 11x is replaced by the light guide panel 11. FIG. 8A shows the relation between the visual angle and the luminance in the liquid crystal device 100. In the embodiment, the angle of inclination α of the grooves having a triangular cross-section formed on the reflecting plane 11b of the light guide panel 11 is set to 3°.

In FIG. 7B described above, the peak of the luminance exists in the area near the center of the screen, that is, the visual angle exists near 0°. In addition, a peak demonstrating a high luminance exists also near the visual angle of 60°. Basically, since the observer views the center of the screen in many cases, it is ideal to concentrate the peaks of the luminance in the area near the center of the screen. As seen in FIG. 8A, in the liquid crystal device 100, peaks of the luminance near 60° are restrained, and the peaks of the luminance may be concentrated in the area near the center of the screen, so that the peaks of the luminance may be increased in the area near the center of the screen. In this manner, by setting the angle of inclination of each groove, being formed on the reflecting plane of the light guide panel and having a triangular cross-section, on the side of the light source 15 to a range from 25° to 3°, the peaks of the luminance can be concentrated to the area near the center of the screen. The range of the value of the angle of inclination α in which the peaks of the luminance are concentrated to the area near the center of the screen may be a certain range including 3°, and in a range from 0.1° to 5°, the peaks of the luminance may be concentrated in the area near the center of the screen.

### Modification

FIG. 5B shows a liquid crystal device 100e as a modification of the liquid crystal device 100 in the embodiment. The liquid crystal device 100e corresponds to the liquid crystal device 100 but a prism sheet 13b having a plurality of beads applied on the surface of the prism sheet 13 on the side of the entrance plane, that is, on the surface on the side of the light guide panel 11 is arranged instead of the diffusing sheet 12 and the prism sheet 13. FIG. 8B shows the relation between the visual angle and the luminance in the liquid crystal device 100e.

As seen in FIG. 8B, in the liquid crystal device 100e according to the modification as well, the prism sheet 13b has the converging function, and hence the luminance in the range of the effective visual angle may be improved as in the case of the liquid crystal device 100 in this embodiment. In the liquid crystal device 100e according to the modification, since the diffusing sheet is not provided, the thin profile is achieved correspondingly.

In the respective embodiments shown above, the light guide panel formed with the grooves having a triangular cross-section is used as the light guide panel on the reflecting plane. However, the light guide panel is not limited thereto, and the light guide panel of a wedge shape may also be employed. In this case, when the angle of inclination of the reflecting plane of the light guide panel is set to a range of 0.1° to 5°, the peaks of the luminance are concentrated to the area near the center of the screen as described above.

In the embodiments shown above, the liquid crystal display panel is employed as the display panel, the invention is not limited thereto, and other display panels such as electrophoresis display panel may be employed as the display panel.

### Electronic Apparatus

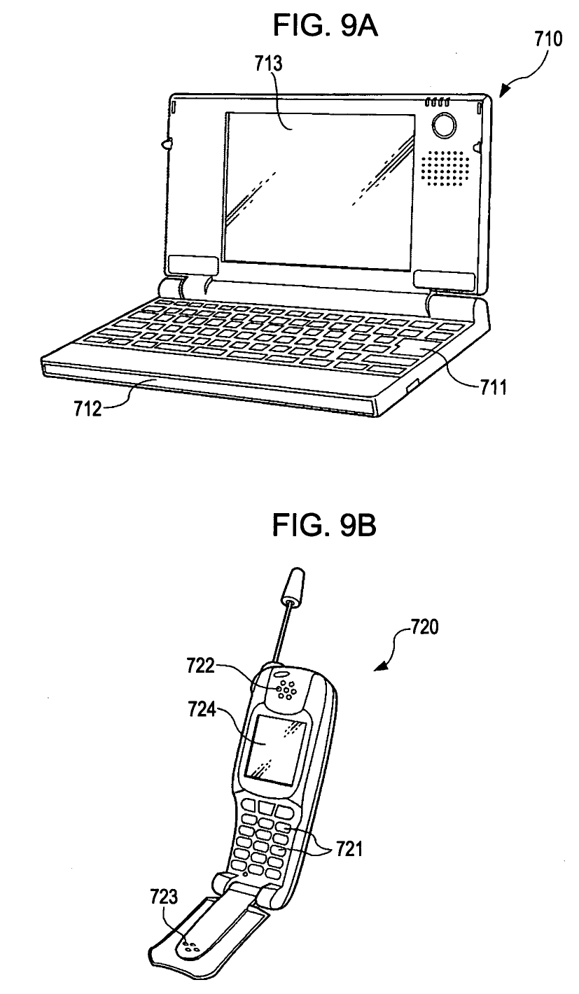

Referring now to FIG. 9, an embodiment of an electronic apparatus to which the liquid crystal device 100 is according to the embodiment of the invention is applicable.

An example in which the liquid crystal device 100 according to the embodiments of the invention is applied to a display unit of a portable personal computer (so-called, notebook personal computer) will be described. FIG. 9A is a perspective view showing a configuration of the personal computer. As shown in the same drawing, a personal computer 710 includes a main body 712 having a keyboard 711 and a display unit 713 in which the liquid crystal device 100 according to the embodiments of the invention is applied.

Subsequently, an example in which the liquid crystal device 100 according to the embodiment of the invention is applied to a display unit of a mobile phone. FIG. 9B is a perspective view showing a configuration of the mobile phone. As shown in the drawing, a mobile phone 720 includes a plurality of operating buttons 721, an ear piece 722, a mouth piece 723 as well as a display unit 724 to which the liquid crystal device 100 according to the embodiments of the invention is applied.

Examples of the electronic apparatus to which the liquid crystal device 100 according to the embodiments of the invention is applicable includes liquid crystal televisions, view finder type or monitor direct-view video tape recorders, car navigation systems, pagers, electronic data books, calculators, word processors, workstations, TV telephones, POS terminals and digital still cameras in addition to the personal computer shown in FIG. 9A and the mobile phone shown in FIG. 9B.

What is claimed is:

1. An electro-optic device comprising:
a light source;
a light guide panel configured to output light beams emitted from the light source through a light exit plane;
a display panel illuminated by the light beams outputted from the light exit plane of the light guide panel passing therethrough;
a prism sheet provided between the light guide panel and the display panel and formed with prisms having a triangular cross-section on a surface on the side of the display panel; and
a light diffusing member provided between the light guide panel and the prism sheet,
wherein the prisms are formed in such a manner that the ridge lines thereof extend substantially vertically to the direction of light beams emitted from the light source, and the apex angle is set to the range from 60° to 70°.

2. The electro-optic device according to claim 1, wherein the light guide panel is formed with grooves having a triangular cross-section on a reflecting plane, and the angle of inclination of the each triangular groove on the side of the light source is set to a range from 0.1 to 5°.

3. The electro-optic device according to claim 1, wherein the light diffusing member is a diffusing sheet, and the diffusing sheet is applied with a plurality of beads on a surface thereof.

4. The electro-optic device according to claim 1, wherein the prism sheet is applied with a plurality of beads on a surface of the prism sheet on the side of the light guide panel as the light diffusing member.

5. The electro-optic device according to claim 1, wherein the display panel is a liquid crystal display panel, and wherein when the vertical direction of the liquid crystal display panel is assumed to be 0°, a range in which the contrast ratio is at least 10:1 is at least ±60° in the lateral direction of the display panel.

6. The electro-optical device according to claim 5, wherein a visual angle compensating layer is provided at least on one side of the display panel.

7. An electronic apparatus comprising the electro-optic device according to claim 1 as a display unit.

8. An illumination device comprising:
a light source;
a light guide panel configured to output light beams emitted from the light source through a light exit plane, and
a prism sheet installed on the side of the light exit plane of the light guide panel and being formed with prisms having a triangular cross-section on a surface opposite from the side of the light guide panel,
wherein the prisms each have a ridge line extending substantially vertically to the direction of emission of the light beam emitted from the light source, and an apex angle is set to a range from 60° to 70°.
